(19) United States
(12) Patent Application Publication
(10) Pub. No.: US 2022/0307835 A1
(43) Pub. Date: Sep. 29, 2022

(54) Laser Level Multi-Tool

(71) Applicant: Frank Basile, Stamford, NY (US)

(72) Inventor: Frank Basile, Stamford, NY (US)

(21) Appl. No.: 17/301,164

(22) Filed: Mar. 29, 2021

(51) Int. Cl. G01C 15/00

(52) U.S. Cl. CPC G01C 15/008

(57) ABSTRACT

The present invention is bubble level and laser level multi-tool. The projection arm with a laser pointer is mounted on a sliding track system of the body section and can be pointed at various angles using a angle degree dial. The projection arm can be folded inside the track system of the body section for storage and transportation.

### FIELD OF INVENTION

In general, the present invention relates to wall mounted bubble level and laser level multi-tool, and specifically to a multi-tool with a projection arm with a laser pointer is mounted on a sliding track system of the body section and can be pointed at various angles using a angle degree dial.

### RELATED APPLICATIONS

U.S. Pat. No. 7,155,835B2: A self-leveling laser alignment tool and method thereof which provides a laser beam in a substantially truly level or plumb orientation are disclosed. Magnetic attraction is used to compensate for leveling errors of an approximately or partially leveled pendulum platform that is suspended from a flexible support member having a predetermined material stiffness. The material stiffness of the suspension member is compensated by using magnets which pulls the pendulum platform into an orientation that is substantially truly level and plumb.

U.S. Pat. No. 7,497,018B2: The present invention provides apparatus and a method for projecting an indication of alignment. The invention features forming a first output beam, and a second output beam that is substantially perpendicular to the first output beam. The first output beam indicates level, the second output beam indicates plumb, and the first and second output beams together indicate square.

U.S. Pat. No. 6,763,596B1: This invention is directed to a novel, portable, self-powered laser alignment device which can simultaneously generate plumb, square and level laser reference points. The laser alignment device is comprised of a main body that is pendulously suspended from a unit housing. The main body is adapted to house a plurality of orthogonally oriented laser diodes that, when energized, produce a plurality of orthogonal output beams to allow the operator to easily mark plumb, square and level reference points. The laser alignment device is self-leveling, which eliminates the time consuming calibration previously required for instrument setup. The movement of the main body is dampened by use of a magnetic dampening system that is comprised of a non-magnetic metallic plate, which is passed through a permanent magnetic field. The housing of the laser alignment device contains the main body, the laser diodes, the dampening system and a power supply to energize the diodes.

U.S. Pat. No. 7,100,293B2: An adapter providing increased versatility to a laser alignment tool is disclosed. Accessories of the adapter are disclosed for use with a laser alignment tool which may or may not be self-leveling. The accessories include one or more laser reference diffraction elements, effective to receive an incoming laser reference and produce a laser reference deviated a predetermined angular amount, and various attachment features.

### BACKGROUND OF THE INVENTION

Traditional leveling tools consist of one or more level vials mounted in a level body. The level body has one or more leveling faces that are calibrated with reference to the level vials such that one of the leveling faces can be placed against a surface and level readings made from the level vials. Laser level devices consist of a body supporting a laser generating device and a lens for focusing the laser. The lens can focus the laser into a beam of light or a plane of light and project the light from the body onto a surface. The light pattern projected on the surface can be used as a reference point for locating and orienting articles. At least one level vial is mounted on the body for orienting the body relative to true plumb or true level to control the projection of the light onto the surface.

A laser is a device that emits light through a process of optical amplification based on the stimulated emission of electromagnetic radiation. The term “laser” originated as an acronym for “light amplification by stimulated emission of radiation”. The first laser was built in 1960 by Theodore H. Maiman at Hughes Research Laboratories, based on theoretical work by Charles Hard Townes and Arthur Leonard Schawlow.

A laser differs from other sources of light in that it emits light which is coherent. Spatial coherence allows a laser to be focused to a tight spot, enabling applications such as laser cutting and lithography. Spatial coherence also allows a laser beam to stay narrow over great distances (collimation), enabling applications such as laser pointers and lidar. Lasers can also have high temporal coherence, which allows them to emit light with a very narrow spectrum, i.e., they can emit a single color of light. Alternatively, temporal coherence can be used to produce pulses of light with a broad spectrum but durations as short as a femtosecond (“ultrashort pulses”).

Lasers are used in optical disk drives, laser printers, barcode scanners, DNA sequencing instruments, fiber-optic, semiconducting chip manufacturing (photolithography), and free-space optical communication, laser surgery and skin treatments, cutting and welding materials, construction, military and law enforcement devices for marking targets and measuring range and speed, and in laser lighting displays for entertainment. They have been used for car headlamps on luxury cars, by using a blue laser and a phosphor to produce highly directional white light.

Laser levels have been used in construction for many years. They typically seek to produce a plane of light for a reference for construction projects. Laser levels have been used for large scale construction projects like commercial excavating, laying foundations, and installing drop ceilings. Laser levels save considerable time during initial layout of a construction job compared to other tools such as beam levels, chalk lines, or torpedo levels. Some examples of jobs where laser levels would be useful include laying tile, mounting cabinets, installing counter tops, and building outdoor decks. Because these laser levels can typically cost thousands of dollars, only those who regularly land larger construction projects can justify purchasing a laser level. Laser levels have not achieved widespread adoption by the general public despite the time savings because of their initial cost of ownership.

In spite of there being a broad category of devices available in the market, there is still room for improvement of what is available. To improve the accuracy of such laser alignment tools further, there are several methods to self-level automatically either the laser or a reflective surface within the laser alignment tool. Although these prior art laser alignment tools have been useful for their intended purposes, a desire for improvements still remains.

More specifically, using a traditional laser level requires the user to set the laser up at the ending point of a project and point the laser at the starting point. The user then adjusts the laser line using traditional tools like a square and chalk line. This requires working backward, becoming time-consuming and complicated. With the improvements provided in the current invention's disclosure of a laser level, the user can set up the right angle at the starting point of the project, point the projection arm to a finishing point, and adjust the angle dial to a desired angle. This facilitates working from front to back, much quicker and easier.

### SUMMARY OF THE INVENTION

The following summary is an explanation of some of the general inventive steps for the tool, method and construction in the description. This summary is not an extensive overview of the invention and does not intend to limit the scope beyond what is described and claimed as a summary.

The present invention is bubble level and laser level multi-tool. The projection arm with a laser pointer is mounted on a sliding track system of the body section and can be pointed at various angles using a angle degree dial. The projection arm can be folded inside the track system of the body section for storage and transportation.

Generally, the invention features a track system to allow the projection arm to slide along and be secured at a desired point. It ensures the user can quickly adjust the laser projection arm to any desired angle with the angle degree dial. It can be mounted on walls and other surfaces for ease of use and convenience, folds into itself for storage and transportation and simultaneously functions as a bubble level or a laser level.

### BRIEF DESCRIPTION OF THE FIGURES

FIG. 1 of the diagrams illustrates a left perspective view of the leveller in a first embodiment.

FIG. 2 of the diagrams is an illustration of right perspective view of the improved leveller in a second embodiment.

FIG. 3 of the diagrams illustrates an exploded leveller device.

FIG. 4 of the diagrams is a further illustration of a leveler with an open channel type of a sliding track.

### DETAILED DESCRIPTION OF THE INVENTION

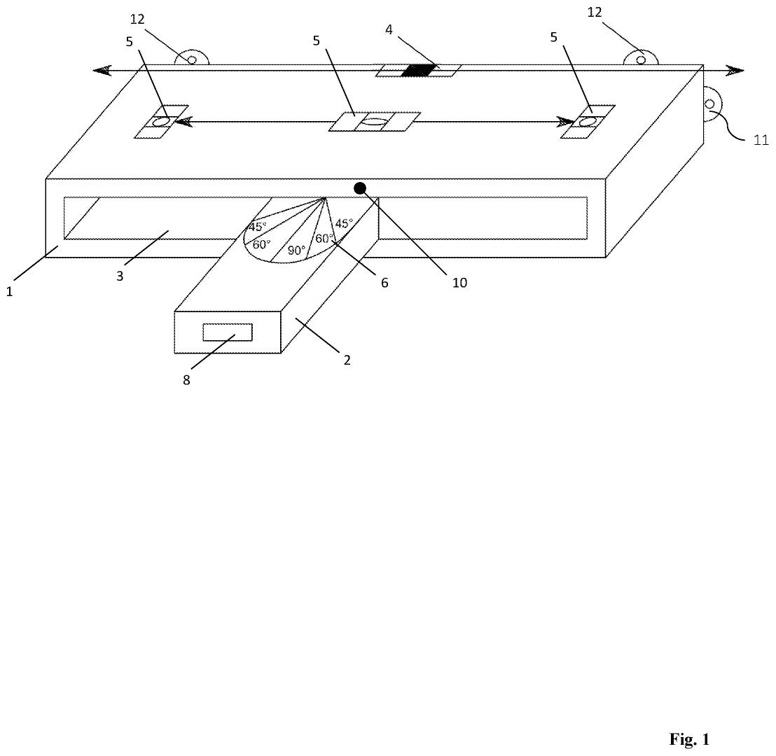

In the first embodiment according to FIG. 1 of the diagrams, it is illustrated an improved laser level multi-tool comprised of a body section 1 with a sliding track system 3 formed generally along the length of the said body section. The body section is capable of accommodating a laser projection arm 2 within said sliding track system 3, wherein the said laser projection arm is adjustably mounted disposed within said sliding track system of the body section, in that its position can change by sliding along the track system or rotating for different variations of utility among other types of movement. A lock mechanism disposed within said sliding track system of the body to adjustably mount the laser projection arm. In its essence, a projection arm has a laser beam source 8 arranged generally at the frontal section of the arm and may be one of lasers that projects a single point type, projects a 180° line or projects a single straight line from the source of the beam.

Further, in the same FIG. 1 of the diagrams is illustrated normal levels 5, preferably but no always mounted on the top surface of the body section. The levels perform the task of indicating the levelness of the multi-tool for efficient operation of its designated tasks. A laser arm lock knob 10 and a degree dial gauge 6 are provided on the body section and projection arm respectively, wherein the degree dial provides suitable measuring method for determining the angle between the body section and the projection arm, and by extension, the angle at which the laser beam source 8 is projected. Also illustrated in the same diagram are wall mounts 12, which allow for the multi-tool to be mounted suitably on a wall for purposes of operation, and a wall leveling knob 11, preferably provided to help adjust the multi-tool to a level position for suitable operation.

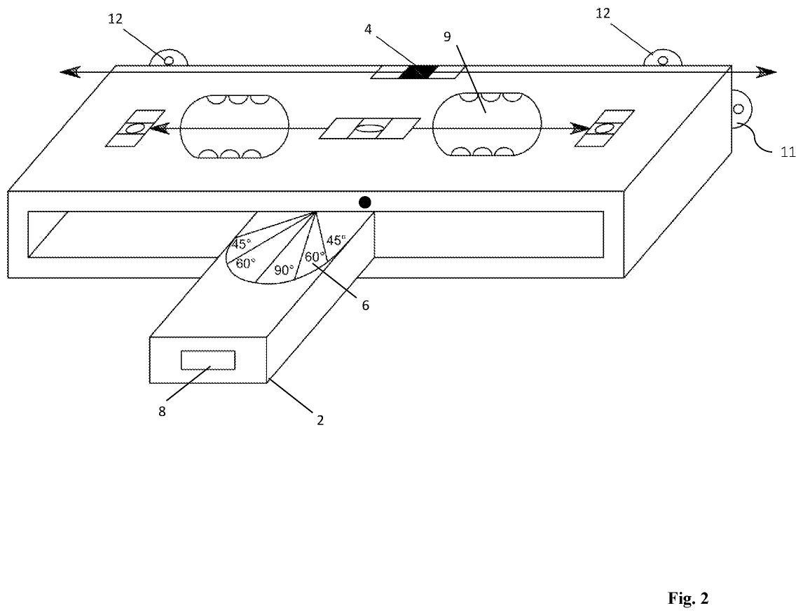

In a second embodiment according to FIG. 2 of the diagrams, it is illustrated an improved laser level multi-tool comprised of a body section 1 with a sliding track system 3 formed generally along the length of the said body section. The body section is capable of accommodating a laser projection arm 2 within said sliding track system 3. Further provided are hand grooves 9 suitably provided to enable holding and handling the multi-tool by an operator. While it is illustrated ad having the hand grooves on the top surface, the said hand grooves could be located anywhere on the body section. A second laser beam source 4 is provided, preferably positioned to project laser beams along the 180° axis. In the preferred embodiment illustrated, the laser beam type is a dedicated laser on the body mounted to project lasers along the 180° plane. It could further be rotatably mounted, and may be one of lasers that projects a single point type, projects a 180° line or projects a single straight line from the source of the beam.

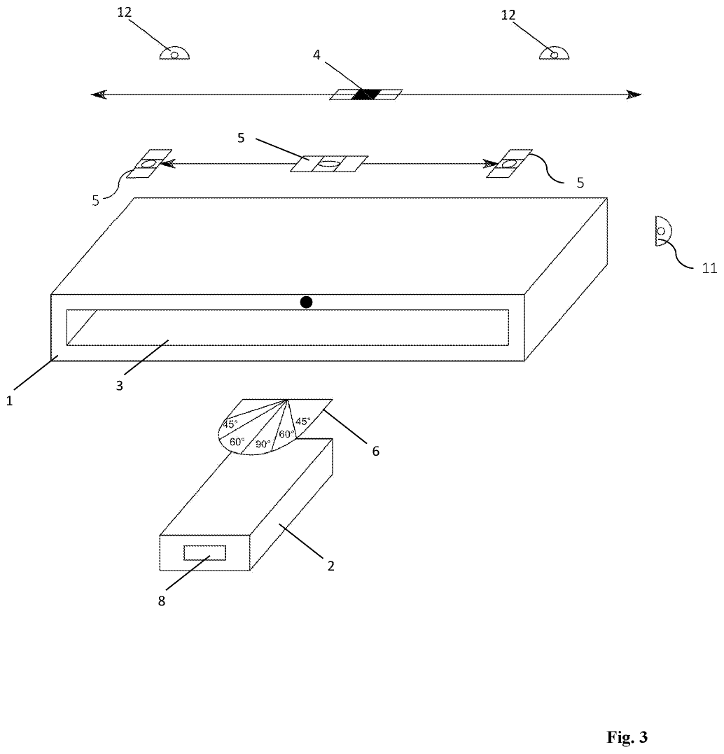

The embodiment according to FIG. 3 of the diagrams illustrates an exploded leveller device. Illustrated is a body section 1 with a sliding track system 3 formed generally along the length of the said body section. The body section is capable of accommodating a laser projection arm 2 within said sliding track system 3, wherein the said laser projection arm is adjustably mounted disposed within said sliding track system of the body section, in that its position can change by sliding along the track system or rotating for different variations of utility among other types of movement. A lock mechanism disposed within said sliding track system of the body to adjustably mount the laser projection arm. In its essence, a projection arm has a laser beam source 8 arranged generally at the frontal section of the arm and may be one of lasers that projects a single point type, projects a 180° line or projects a single straight line from the source of the beam.

Further illustrated on the exploded view of the diagram is are normal levels 5, preferably but no always mountable on the top surface of the body section. A degree dial gauge 6 are provided mountable on the body section and projection arm respectively, wherein the degree dial provides suitable measuring method for determining the angle between the body section and the projection arm, and by extension, the angle at which the laser beam source 8 is projected. Also illustrated in the same diagram are wall mounts 12, which allow for the multi-tool to be mounted suitably on a wall for purposes of operation, and a wall leveling knob 11, preferably provided to help adjust the multi-tool to a level position for suitable operation.

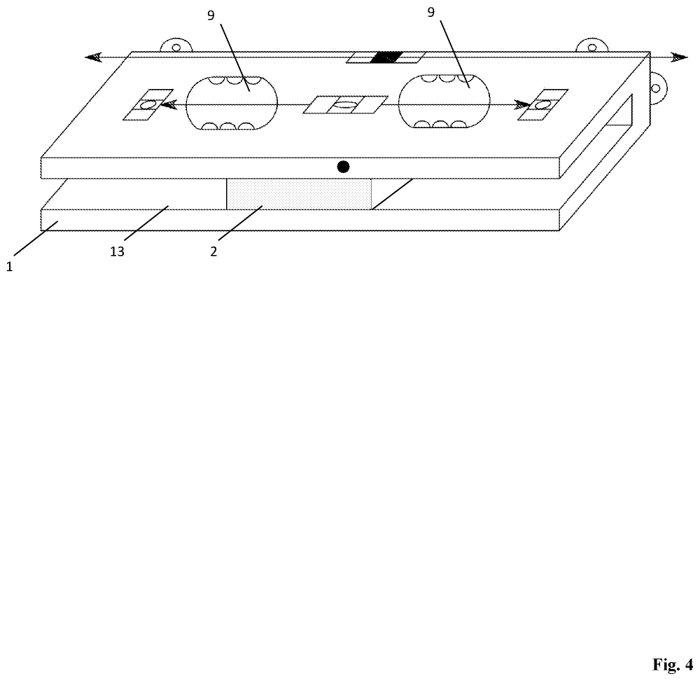

The FIG. 4 of the diagrams is an illustration of an alternative embodiment of a leveler with an open channel type of a sliding track 13. The objective of having the open type of channel as in the diagram is to provide for a projection arm that has a near 360° field of view, as it is rotatably mounted in said sliding track. Illustrated in the diagram is a projection arm 2 in a folded position, wherein the laser beam source 8 of the projection arm is projected generally parallel along the body section.

### INDUSTRIAL APPLICATION

The invention is generally applicable in the measuring devices construction and the use thereof.

What is claimed is:

1. An improved laser level multi-tool comprised of:
a body section with a sliding track system formed generally along the length of the said section, capable of accommodating a laser projection arm;
a laser projection arm adjustably mounted disposed within said sliding track system of the body section, said projection arm having a laser beam source arranged generally at the frontal section, and;
a lock mechanism disposed within said sliding track system of the body to adjustably mount the laser projection arm.

2. The improved laser level multi-tool as in claim 1, further comprising a degree dial provided for adjusting the laser projection arm to any desired angle with respect to the body section.

3. The improved laser level multi-tool as in claim 1, wherein the sliding track system is an open ended track capable of providing projection of a laser by the projection arm while said arm is flash to the body section.

4. The improved laser level multi-tool as in claim 1, further comprising a knob capable of fixating the projection arm at a given angle with respect to the body.

5. The improved laser level multi-tool as in claim 1, further comprising holding grooves where human fingers can hold and carry the multi-tool.

6. The improved laser level multi-tool as in claim 1, wherein the projection arm has 180° field of view.

7. The improved laser level multi-tool as in claim 1, wherein the projection arm has a near 360° field of view.

8. The improved laser level multi-tool as in claim 1, wherein the laser projection arm projects a single point type.

9. The improved laser level multi-tool as in claim 1, wherein the laser projection arm projects a 180° line.

10. The improved laser level multi-tool as in claim 1, wherein the laser projection arm projects a single straight line.

11. The improved laser level multi-tool as in claim 1, further comprising of a dedicated laser on the body to project lasers along the 180° plane.

12. A method of providing an improved laser level multi-tool, the method comprising of:
providing a body section with a sliding track system formed generally along the length of the said section, capable of accommodating a laser projection arm;
providing a laser projection arm adjustably mounted disposed within said sliding track system of the body section, said projection arm having a laser beam source arranged generally at the frontal section;
providing a lock mechanism disposed within said sliding track system of the body to adjustably mount the laser projection arm, and;
providing a degree dial for adjusting the laser projection arm to any desired angle with respect to the body section.

13. The method of claim 12, further comprising providing an open ended track capable of providing projection of a laser by the projection arm while said arm is flash to the body section.

14. The method of claim 12, further comprising providing a knob capable of fixating the projection arm at a given angle with respect to the body.
